(19) United States
(12) Patent Application Publication
(10) Pub. No.: US 2026/0270739 A1
(43) Pub. Date: Sep. 10, 2026

(54) SPATIAL QUASI CO-LOCATION FOR CROSS-LINK INTERFERENCE FOR MULTIPLE TRANSMISSION AND RECEPTION POINTS

(71) Applicant: QUALCOMM Incorporated, San Diego, CA (US)

(72) Inventors: Huilin XU, Beijing (CN); Yuwei REN, Beijing (CN); Mostafa KHOSHNEVISAN, San Diego, CA (US); Jing LEI, San Diego, CA (US)

(21) Appl. No.: 19/166,224

(22) PCT Filed: Apr. 23, 2023
(86) PCT No.: PCT/CN2023/090029

§ 371 Date: Sep. 17, 2025

(51) Int. Cl. H04W 24/08; H04B 17/318; H04W 72/232

(52) U.S. Cl. CPC H04W 24/08; H04B 17/328; H04W 72/232

(57) ABSTRACT

Various aspects of the present disclosure generally relate to wireless communication. In some aspects, a user equipment (UE) may identify, from multiple transmission reception points (TRPs) in communication with the UE, a first TRP associated with a cross-link interference (CLI) measurement. The UE may measure CLI using a receive beam associated with the first TRP. Numerous other aspects are described.

### FIELD OF THE DISCLOSURE

Aspects of the present disclosure generally relate to wireless communication and to techniques and apparatuses for spatial quasi co-location for cross-link interference for multiple transmission and reception points.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 illustrates an example logical architecture of a distributed radio access network (RAN), in accordance with the present disclosure.

FIG. 5 is a diagram illustrating an example of multi-transmission reception point (TRP) communication (sometimes referred to as multi-panel communication), in accordance with the present disclosure.

FIG. 6 is a diagram illustrating an example relating to cross-link interference detection and mitigation, in accordance with the present disclosure.

FIG. 7 is a diagram illustrating an example associated with spatial quasi co-location (QCL) for cross-link interference (CLI) for multiple TRPs, in accordance with the present disclosure.

FIG. 8 is a diagram illustrating an example process performed, for example, by a UE, in accordance with the present disclosure.

FIG. 9 is a diagram illustrating an example process performed, for example, by a network node, in accordance with the present disclosure.

FIG. 10 is a diagram illustrating an example process performed, for example, by a UE, in accordance with the present disclosure.

FIG. 11 is a diagram of an example apparatus for wireless communication, in accordance with the present disclosure.

FIG. 12 is a diagram of an example apparatus for wireless communication, in accordance with the present disclosure.

### SUMMARY

Some aspects described herein relate to a method of wireless communication performed by a user equipment (UE). The method may include identifying, from multiple transmission reception points (TRPs) in communication with the UE, a first TRP associated with a cross-link interference (CLI) measurement. The method may include measuring CLI using a receive beam associated with the first TRP.

Some aspects described herein relate to a method of wireless communication performed by a network node. The method may include transmitting, to a UE, configuration information, the configuration information indicating that the UE is to identify, from multiple TRPs in communication with the UE, a first TRP associated with a CLI measurement; and measure CLI using a receive beam associated with the first TRP. The method may include receiving a CLI report based at least in part on the configuration information.

Some aspects described herein relate to a method of wireless communication performed by a UE. The method may include identifying, from multiple TRPs in communication with the UE, at least two TRPs associated with CLI measurements. The method may include measuring CLI for each of the at least two TRPs.

Some aspects described herein relate to a UE for wireless communication. The user equipment may include a memory and one or more processors coupled to the memory. The one or more processors may be configured to identify, from multiple TRPs in communication with the UE, a first TRP associated with a CLI measurement. The one or more processors may be configured to measure CLI using a receive beam associated with the first TRP.

Some aspects described herein relate to a network node for wireless communication. The network node may include a memory and one or more processors coupled to the memory. The one or more processors may be configured to transmit, to a UE, configuration information, the configuration information indicating that the UE is to identify, from multiple TRPs in communication with the UE, a first TRP associated with a CLI measurement; and measure CLI using a receive beam associated with the first TRP. The one or more processors may be configured to receive a CLI report based at least in part on the configuration information.

Some aspects described herein relate to a UE for wireless communication. The UE may include a memory and one or more processors coupled to the memory. The one or more processors may be configured to identify, from multiple TRPs in communication with the UE, at least two TRPs associated with CLI measurements. The one or more processors may be configured to measure CLI for each of the at least two TRPs.

Some aspects described herein relate to a non-transitory computer-readable medium that stores a set of instructions for wireless communication by a UE. The set of instructions, when executed by one or more processors of the UE, may cause the UE to identify, from multiple TRPs in communication with the UE, a first TRP associated with a CLI measurement. The set of instructions, when executed by one or more processors of the UE, may cause the UE to measure CLI using a receive beam associated with the first TRP.

Some aspects described herein relate to a non-transitory computer-readable medium that stores a set of instructions for wireless communication by a network node. The set of instructions, when executed by one or more processors of the network node, may cause the network node to transmit, to a UE, configuration information, the configuration information indicating that the UE is to identify, from multiple TRPs in communication with the UE, a first TRP associated with a CLI measurement; and measure CLI using a receive beam associated with the first TRP. The set of instructions, when executed by one or more processors of the network node, may cause the network node to receive a CLI report based at least in part on the configuration information.

Some aspects described herein relate to a non-transitory computer-readable medium that stores a set of instructions for wireless communication by a one or more instructions that, when executed by one or more processors of a UE. The set of instructions, when executed by one or more processors of the one or more instructions that, when executed by one or more processors of a UE, may cause the one or more instructions that, when executed by one or more processors of a UE to identify, from multiple TRPs in communication with the UE, at least two TRPs associated with CLI measurements. The set of instructions, when executed by one or more processors of the one or more instructions that, when executed by one or more processors of a UE, may cause the one or more instructions that, when executed by one or more processors of a UE to measure CLI for each of the at least two TRPs.

Some aspects described herein relate to an apparatus for wireless communication. The apparatus may include means for identifying, from multiple TRPs in communication with a UE, a first TRP associated with a CLI measurement. The apparatus may include means for measuring CLI using a receive beam associated with the first TRP.

Some aspects described herein relate to an apparatus for wireless communication. The apparatus may include means for transmitting, to a UE, configuration information, the configuration information indicating that the UE is, means for identifying, from multiple TRPs in communication with the UE, a first TRP associated with a CLI measurement means for measuring CLI using a receive beam associated with the first TRP. The apparatus may include means for receiving a CLI report based at least in part on the configuration information.

Some aspects described herein relate to an apparatus for wireless communication. The apparatus may include means for identifying, from multiple TRPs in communication with a UE, at least two TRPs associated with CLI measurements. The apparatus may include means for measuring CLI for each of the at least two TRPs.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### DETAILED DESCRIPTION

In a multiple transmission reception point (TRP) situation, the TRPs with which a user equipment (UE) communicates are likely to have separate spatial filters (e.g., separate receive beams). If the UE measures cross-link interference (CLI) using the most recently-used spatial filter, it is possible that only one of the multiple receive beams being used by the UE are used for measuring CLI. This may cause the UE to miss measuring CLI on other resources (e.g., other receive beams) that the UE may be using to communicate with the TRPs, which means that the CLI measurement may be incomplete. When multi-TRP communications for the UE are multiplexed (e.g., using time division multiplexing (TDM), spatial division multiplexing (SDM), and/or frequency division multiplexing (FDM)), this may further complicate CLI measurements for the UE. For example, for SDM and FDM, the UE may have multiple beams and/or frequency ranges to measure, and when using TDM, the most recently used receive beam may not be the next beam used for receiving communications. In this situation, when measuring CLI, the UE may miss measuring resources used in the multi-TRP configuration being used for communications, which may result in CLI not being identified, being misidentified, and/or not being addressed.

Some techniques and apparatuses described herein enable spatial quasi co-location (QCL) for CLI for multi-TRP communications. For example, a UE may identify, from multiple TRPs, a TRP to be associated with CLI measurement and use that TRP for measuring CLI. In this situation, the TRP may be chosen based at least in part on a downlink control information (DCI) source, configuration, or a default choice. As another example, a UE may identify at least two TRPs to be associated with CLI measurement and prepare results of measuring CLI for use in avoiding CLI across the multiple TRPs. In this way, the UE may determine which TRP(s) should be used for measuring CLI and, in some aspects, how to handle the results of measuring CLI for multiple TRPs.

As a result, the UE may be more selective regarding which of multiple TRPs are chosen for measuring CLI, which may result in more relevant CLI measurements for the UE. More relevant CLI measurements are more likely to be useful in determining how the UE should avoid interference with another UE. The avoidance of interference may improve the quality of network communications and reduce network overhead that might otherwise be incurred correcting for interference.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

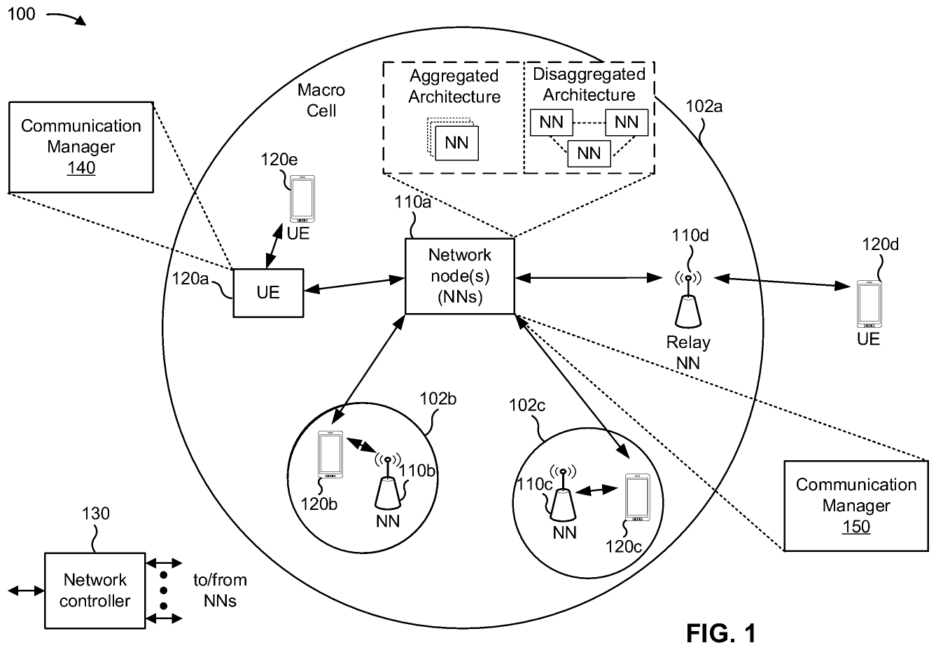

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a TRP, a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHZ) and FR2 (24.25 GHz-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHZ), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may identify, from multiple TRPs in communication with the UE, at least two TRPs associated with CLI measurements; and measure CLI for each of the at least two TRPs. In some aspects, the communication manager 140 may identify, from multiple TRPs in communication with the UE, a first TRP associated with a CLI measurement; and measure CLI using a receive beam associated with the first TRP. Additionally, or alternatively, the communication manager 140 may perform one or more other operations described herein.

In some aspects, the network node 110 may include a communication manager 150. As described in more detail elsewhere herein, the communication manager 150 may transmit, to a UE, configuration information, the configuration information indicating that the UE is to: identify, from multiple TRPs in communication with the UE, a first TRP associated with a CLI measurement; and measure CLI using a receive beam associated with the first TRP; and receive a CLI report based at least in part on the configuration information. Additionally, or alternatively, the communication manager 150 may perform one or more other operations described herein.

As indicated above, FIG. 1 is provided as an example. Other examples may differ from what is described with regard to FIG. 1.

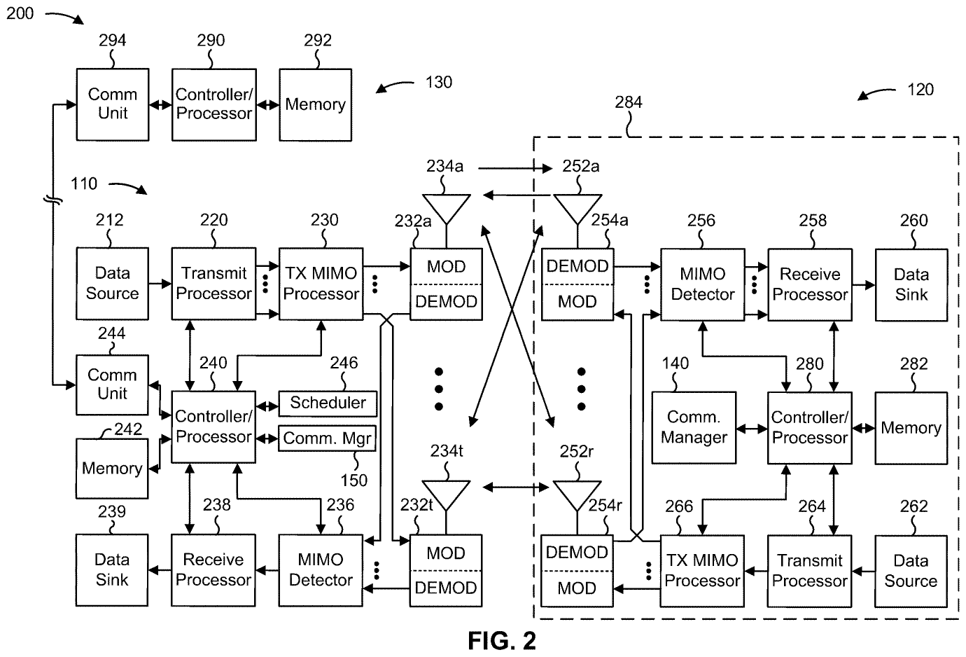

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

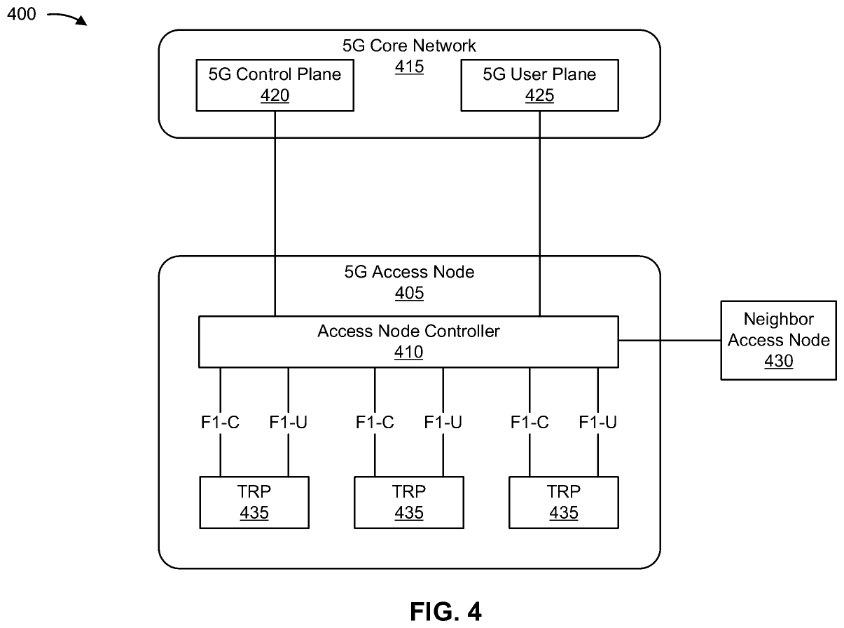

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-12).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-12).

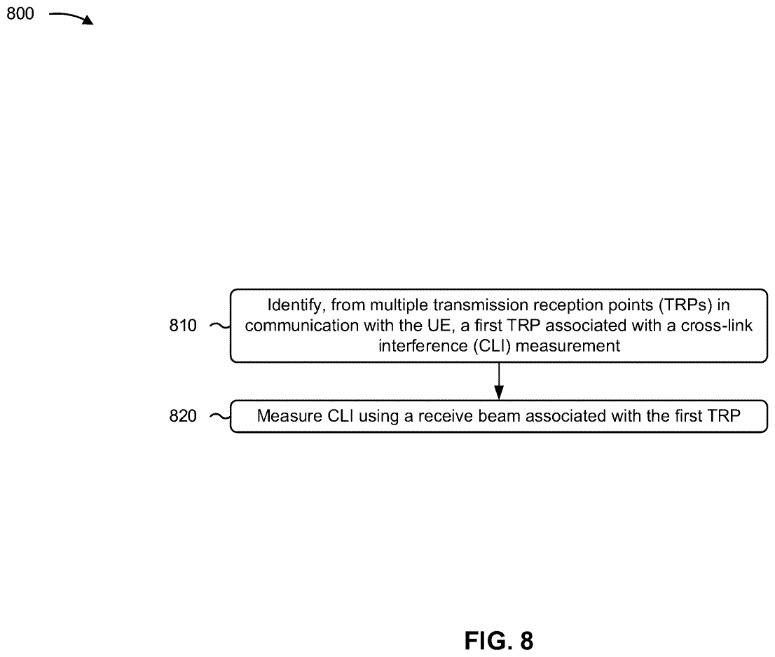

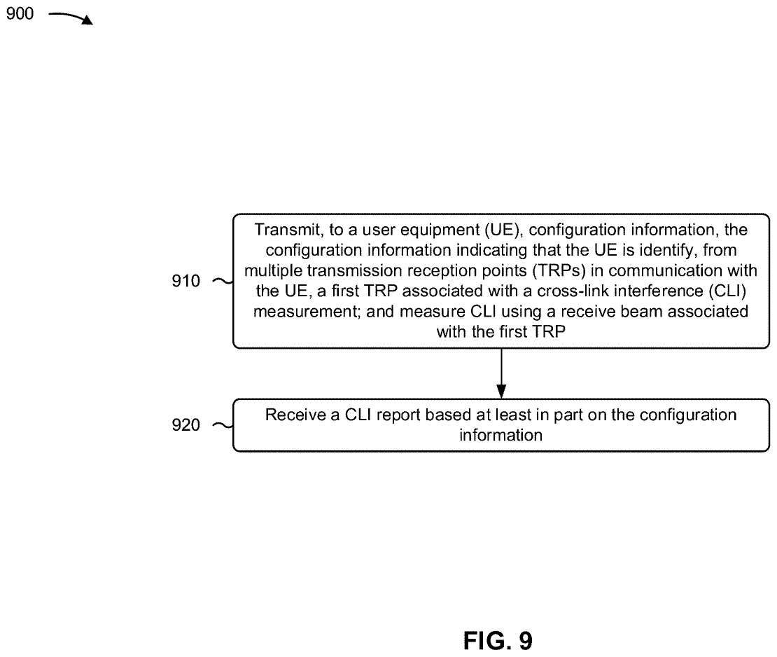

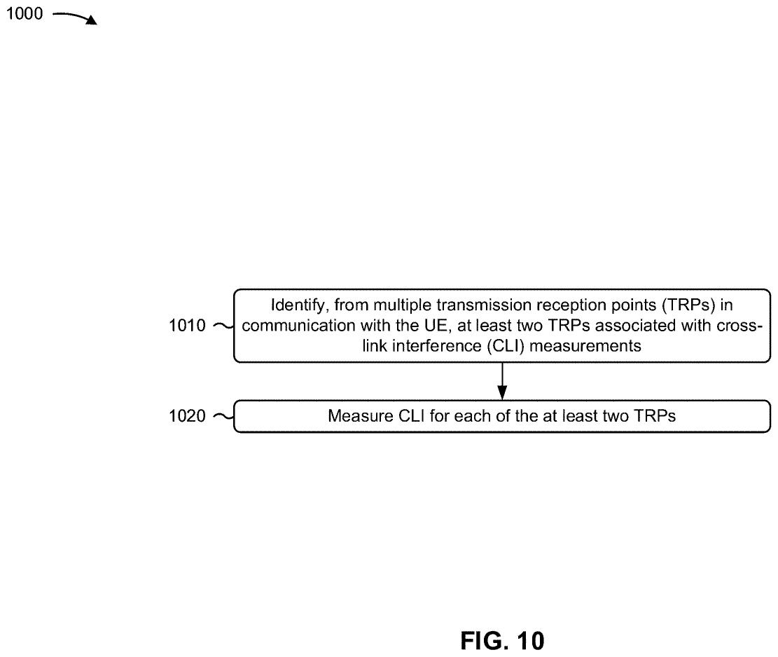

The controller/processor 240 of the network node 110, the controller/processor 280 of the UE 120, and/or any other component(s) of FIG. 2 may perform one or more techniques associated with spatial QCL for CLI for multiple TRPs, as described in more detail elsewhere herein. For example, the controller/processor 240 of the network node 110, the controller/processor 280 of the UE 120, and/or any other component(s) of FIG. 2 may perform or direct operations of, for example, process 800 of FIG. 8, process 900 of FIG. 9, process 1000 of FIG. 10, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 800 of FIG. 8, process 900 of FIG. 9, process 1000 of FIG. 10, and/or other processes as described herein. In some examples, executing instructions may include running the instructions, converting the instructions, compiling the instructions, and/or interpreting the instructions, among other examples.

In some aspects, the UE includes means for identifying, from multiple TRPs in communication with the UE, at least two TRPs associated with CLI measurements; and/or means for measuring CLI for each of the at least two TRPs. In some aspects, the UE includes means for identifying, from multiple TRPs in communication with the UE, a first TRP associated with a CLI measurement; and measuring CLI using a receive beam associated with the first TRP The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 may include a communication manager 150. As described in more detail elsewhere herein, the communication manager 150 may transmit, to a UE, configuration information, the configuration information indicating that the UE is to: identify, from multiple TRPs in communication with the UE, a first TRP associated with a CLI measurement; and measure CLI using a receive beam associated with the first TRP; and receive a CLI report based at least in part on the configuration information. Additionally, or alternatively, the communication manager 150 may perform one or more other operations described herein.

In some aspects, base station 110 may include means for transmitting, to a UE, configuration information, the configuration information indicating that the UE is to: identify, from multiple TRPs in communication with the UE, a first TRP associated with a CLI measurement; and measure CLI using a receive beam associated with the first TRP; and means for receiving a CLI report based at least in part on the configuration information, or the like. In some aspects, such means may include one or more components of base station 110 described in connection with FIG. 2, such as antenna 234, MIMO detector 236, receive processor 238, controller/processor 240, transmit processor 220, TX MIMO processor 230, modem 232, antenna 234, or the like.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

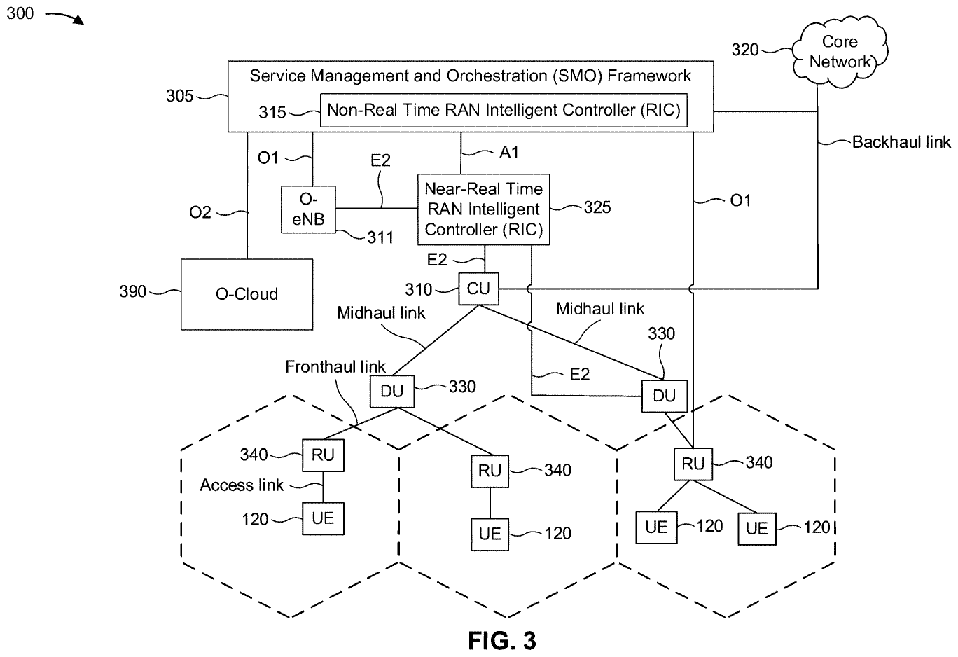

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

FIG. 4 illustrates an example logical architecture of a distributed RAN 400, in accordance with the present disclosure.

A 5G access node 405 may include an access node controller 410. The access node controller 410 may be a CU of the distributed RAN 400. In some aspects, a backhaul interface to a 5G core network 415 may terminate at the access node controller 410. The 5G core network 415 may include a 5G control plane component 420 and a 5G user plane component 425 (e.g., a 5G gateway), and the backhaul interface for one or both of the 5G control plane and the 5G user plane may terminate at the access node controller 410. Additionally, or alternatively, a backhaul interface to one or more neighbor access nodes 430 (e.g., another 5G access node 405 and/or an LTE access node) may terminate at the access node controller 410.

The access node controller 410 may include and/or may communicate with one or more TRPs 435 (e.g., via an F1 Control (F1-C) interface and/or an F1 User (F1-U) interface). A TRP 435 may include a DU and/or a RU of the distributed RAN 400. In some aspects, a TRP 435 may correspond to a network node 110 described above in connection with FIG. 1. For example, different TRPs 435 may be included in different network nodes 110. Additionally, or alternatively, multiple TRPs 435 may be included in a single network node 110. In some aspects, a network node 110 may include a CU (e.g., access node controller 410) and/or one or more DUs (e.g., one or more TRPs 435). In some cases, a TRP 435 may be referred to as a cell, a panel, an antenna array, or an array.

A TRP 435 may be connected to a single access node controller 410 or to multiple access node controllers 410. In some aspects, a dynamic configuration of split logical functions may be present within the architecture of distributed RAN 400, referred to elsewhere herein as a functional split. For example, a PDCP layer, a RLC layer, and/or a MAC layer may be configured to terminate at the access node controller 410 or at a TRP 435.

In some aspects, multiple TRPs 435 may transmit communications (e.g., the same communication or different communications) in the same transmission time interval (TTI) (e.g., a slot, a mini-slot, a subframe, or a symbol) or different TTIs using different quasi co-location (QCL) relationships (e.g., different spatial parameters, different transmission configuration indicator (TCI) states, different precoding parameters, and/or different beamforming parameters). In some aspects, a TCI state may be used to indicate one or more QCL relationships. A TRP 435 may be configured to individually (e.g., using dynamic selection) or jointly (e.g., using joint transmission with one or more other TRPs 435) serve traffic to a UE 120.

As indicated above, FIG. 4 is provided as an example. Other examples may differ from what was described with regard to FIG. 4.

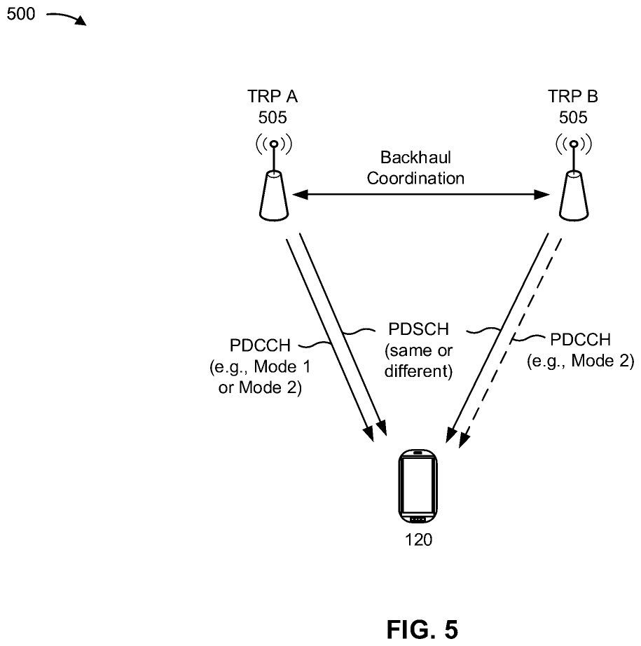

FIG. 5 is a diagram illustrating an example 500 of multi-TRP communication (sometimes referred to as multi-panel communication), in accordance with the present disclosure. As shown in FIG. 5, multiple TRPs 505 may communicate with the same UE 120. A TRP 505 may correspond to a TRP 435 described above in connection with FIG. 4.

The multiple TRPs 505 (shown as TRP A and TRP B) may communicate with the same UE 120 in a coordinated manner (e.g., using coordinated multipoint transmissions) to improve reliability and/or increase throughput. The TRPs 505 may coordinate such communications via an interface between the TRPs 505 (e.g., a backhaul interface and/or an access node controller 410). The interface may have a smaller delay and/or higher capacity when the TRPs 505 are co-located at the same network node 110 (e.g., when the TRPs 505 are different antenna arrays or panels of the same network node 110), and may have a larger delay and/or lower capacity (as compared to co-location) when the TRPs 505 are located at different network nodes 110. The different TRPs 505 may communicate with the UE 120 using different QCL relationships (e.g., different TCI states), different DMRS ports, and/or different layers (e.g., of a multi-layer communication).

In a first multi-TRP transmission mode (e.g., Mode 1, or single DCI configuration), a single physical downlink control channel (PDCCH) may be used to schedule downlink data communications for a single physical downlink shared channel (PDSCH). In this case, multiple TRPs 505 (e.g., TRP A and TRP B) may transmit communications to the UE 120 on the same PDSCH. For example, a communication may be transmitted using a single codeword with different spatial layers for different TRPs 505 (e.g., where one codeword maps to a first set of layers transmitted by a first TRP 505 and maps to a second set of layers transmitted by a second TRP 505). As another example, a communication may be transmitted using multiple codewords, where different codewords are transmitted by different TRPs 505 (e.g., using different sets of layers). In either case, different TRPs 505 may use different QCL relationships (e.g., different TCI states) for different DMRS ports corresponding to different layers. For example, a first TRP 505 may use a first QCL relationship or a first TCI state for a first set of DMRS ports corresponding to a first set of layers, and a second TRP 505 may use a second (different) QCL relationship or a second (different) TCI state for a second (different) set of DMRS ports corresponding to a second (different) set of layers. In some aspects, a TCI state in DCI) (e.g., transmitted on the PDCCH, such as DCI format 1_0 or DCI format 1_1) may indicate the first QCL relationship (e.g., by indicating a first TCI state) and the second QCL relationship (e.g., by indicating a second TCI state). The first and the second TCI states may be indicated using a TCI field in the DCI. In general, the TCI field can indicate a single TCI state (for single-TRP transmission) or multiple TCI states (for multi-TRP transmission as discussed here) in this multi-TRP transmission mode (e.g., Mode 1).

In a second multi-TRP transmission mode (e.g., Mode 2, or multi-DCI configuration), multiple PDCCHs may be used to schedule downlink data communications for multiple corresponding PDSCHs (e.g., one PDCCH for each PDSCH). In this case, a first PDCCH may schedule a first codeword to be transmitted by a first TRP 505, and a second PDCCH may schedule a second codeword to be transmitted by a second TRP 505. Furthermore, first DCI (e.g., transmitted by the first TRP 505) may schedule a first PDSCH communication associated with a first set of DMRS ports with a first QCL relationship (e.g., indicated by a first TCI state) for the first TRP 505, and second DCI (e.g., transmitted by the second TRP 505) may schedule a second PDSCH communication associated with a second set of DMRS ports with a second QCL relationship (e.g., indicated by a second TCI state) for the second TRP 505. In this case, DCI (e.g., having DCI format 1_0 or DCI format 1_1) may indicate a corresponding TCI state for a TRP 505 corresponding to the DCI. The TCI field of a DCI indicates the corresponding TCI state (e.g., the TCI field of the first DCI indicates the first TCI state and the TCI field of the second DCI indicates the second TCI state).

As indicated above, FIG. 5 is provided as an example. Other examples may differ from what is described with respect to FIG. 5.

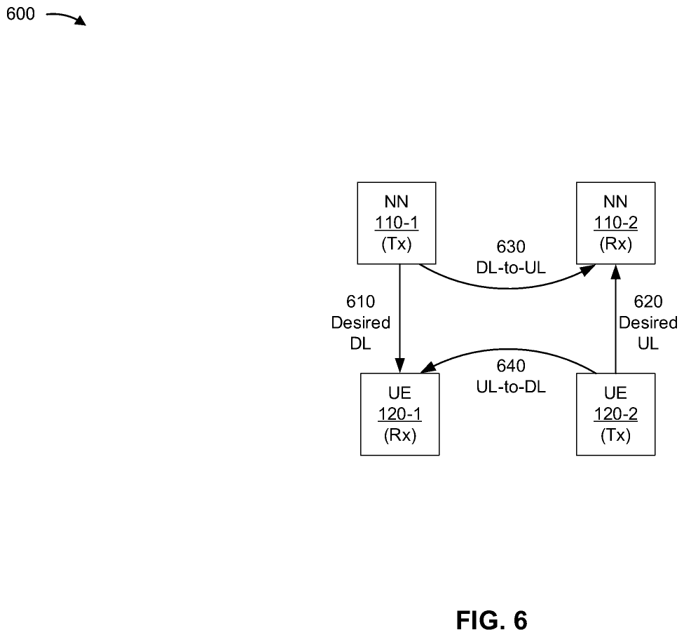

FIG. 6 is a diagram illustrating an example 600 relating to cross-link interference detection and mitigation, in accordance with the present disclosure.

In dynamic time division duplexing (TDD), the allocation of network resources to uplink and downlink may be dynamically modified depending on a traffic load. For example, a network node 110 may configure a TDD configuration (e.g., a TDD pattern) with more uplink TTIs (e.g., frames, subframes, slots, mini-slots, and/or symbols) for a UE 120 when the UE 120 has uplink data to transmit, and may configure a TDD configuration with more downlink TTIs for the UE 120 when the UE 120 has downlink data to receive. The TDD configuration may be dynamically configured to modify the allocation of uplink TTIs and downlink TTIs used for communication between the network node 110 and the UE 120.

As shown in FIG. 6, when neighboring network nodes 110 use different TDD configurations to communicate with UEs 120, this may result in a downlink communication 610 between a first network node 110-1 and a first UE 120-1 in a same TTI as an uplink communication 620 between a second network node 110-2 and a second UE 120-2. These communications in different transmission directions (e.g., downlink vs. uplink) in the same TTI may interfere with one another, which may be referred to as cross-link interference.

For example, as shown by reference number 630, the downlink communication 610 transmitted by the first network node 110-1 may be received by the second network node 110-2, and may interfere with reception, by the second network node 110-2, of the uplink communication 620 from the second UE 120-2. This may be referred to as downlink-to-uplink (DL-to-UL) interference, network node to network node interference, or gNB-to-gNB interference.

Further, as shown by reference number 640, the uplink communication 620 transmitted by the second UE 120-2 may be received by the first UE 120-1, and may interfere with reception, by the first UE 120-1, of the downlink communication 610 from the first network node 110-1. This may be referred to as uplink-to-downlink (UL-to-DL) interference or UE-to-UE interference. This UE to UE interference may occur and/or may increase when the first UE 120-1 and the second UE 120-2 are in close proximity, and may be avoided or mitigated by preventing scheduling of the UEs 120 in different transmission directions in the same TTI. In some situations, UE to UE interference may also occur between UEs in the same cell using the same network node when the network node configures different TDD configurations for the UEs.

In some situations, CLI between UEs may be managed by CLI measurements performed by a UE. For example, the first UE 120-1 may measure CLI by measuring the signal strength of signals transmitted by the second UE 120-2 in CLI measurement resource or CLI measurement occasion. For example, the first UE 120-1 may measure an RSRP value for an uplink sounding reference signal (SRS) transmitted by the second UE 120-2. As another example, the first UE 120-1 may measure a total signal strength (e.g., RSSI) within a configured bandwidth. The measured signal strength in the CLI measurement resource provides an indication of the CLI experienced by the first UE 120-1 due to the uplink transmission(s) of the second UE 120-2.

To determine spatial resources or filter for measuring CLI, the first UE 120-1 may use the same spatial filter (e.g., a QCL TypeD, spatial QCL, Rx beam, and/or the like) as the most recently received PDSCH communication and/or the most recently monitored control resource set (CORESET). This enables the first UE 120-1 to determine CLI.

However, in a multi-TRP situation, the TRPs with which the first UE 120-1 communicates are likely to have separate spatial filters (e.g., separate receive beams). In this situation, the most recently used spatial filter may only indicate CLI for one of the multiple receive beams being used by the first UE 120-1. Measuring CLI using the most recently used resources may cause the first UE 120-1 to miss measuring CLI on other resources that the first UE 120-1 may be using to communicate with the TRPs, which means that the CLI measurement may be incomplete. When multi-TRP communications for the first UE 120-1 are multiplexed (e.g., using TDM, SDM, and/or FDM), this may further complicate CLI measurements for the first UE 120-1. For example, for SDM and FDM, the first UE 120-1 may have multiple beams and/or frequency ranges to measure and, as noted herein, when using TDM the most recently used receive beam may not be the next beam used for receiving communications. In this situation, when measuring CLI, the first UE 120-1 may miss measuring resources used in the multi-TRP configuration being used for communications, which may result in CLI not being identified, being misidentified, and/or not being addressed.

As indicated above, FIG. 6 is provided as an example. Other examples are possible and may differ from what was described with respect to FIG. 6.

Some techniques and apparatuses described herein enable spatial QCL for CLI for multi-TRP communications. For example, a UE may identify, from multiple TRPs, a TRP to be associated with CLI measurement and use that TRP for measuring CLI. In this situation, the TRP may be chosen based at least in part on a DCI source, configuration, or a default choice. As another example, a UE may identify at least two TRPs to be associated with CLI measurement and prepare results of measuring CLI for use in avoiding CLI measurement across the multiple TRPs. In this way, the UE may determine which TRP(s) should be used for measuring CLI and, in some aspects, how to handle the results of measuring CLI for multiple TRPs. As a result, the UE may be more selective regarding which of multiple TRPs are chosen for measuring CLI, which may result in more relevant CLI measurements for the UE. More relevant CLI measurements are more likely to be useful in determining how the UE should avoid interference with another UE. The avoidance of interference may improve the quality of network communications and reduce network overhead that might otherwise be incurred correcting for interference.

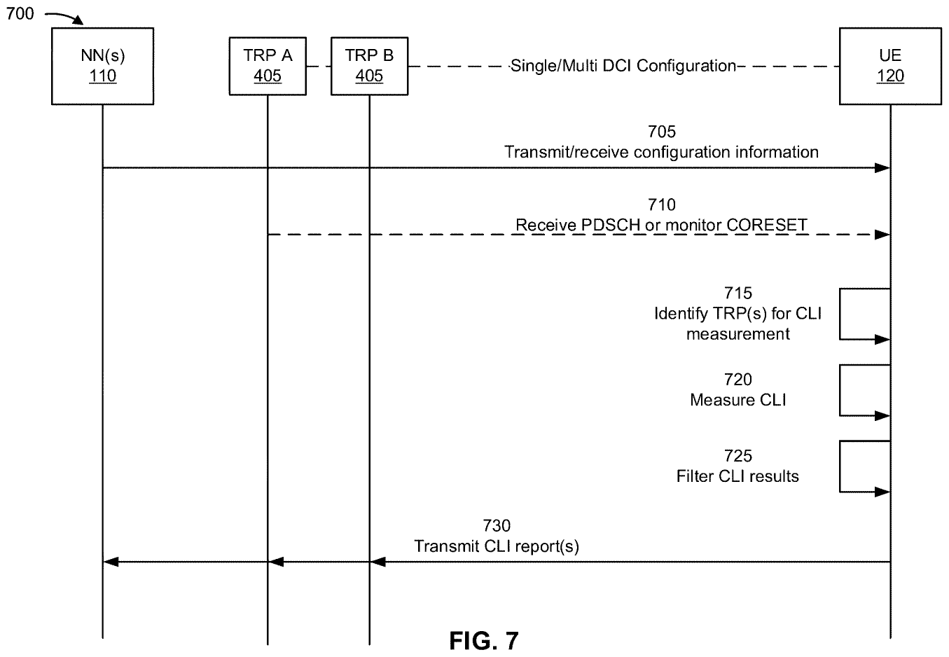

FIG. 7 is a diagram illustrating an example 700 associated with spatial QCL for CLI for multiple TRPs, in accordance with the present disclosure. As shown in FIG. 7, a network node 110, TRPs (e.g., TRP 405), and a UE 120 may communicate with one another. The TRPs, identified as TRP A and TRP B, may also be network nodes (e.g., network nodes 110), and the network node (e.g., network node 110) may also be a TRP (e.g., TRP 405). The TRPs may be in communication with the UE in a single DCI (e.g., Mode 1) or multi-DCI (e.g., Mode 2) configuration. For example, and as described herein, in the single DCI configuration, one TRP (e.g., TRP A or TRP B) may transmit DCI via PDCCH for scheduling communications with both TRPs. In the multi-DCI configuration, each TRP may transmit DCI separately via separate PDCCHs to schedule communications with the TRPs. The UE, network node, and TRPs may have established wireless connections prior to operations shown in FIG. 7.

As shown by reference number 705, the network node or TRPs may transmit (directly or via one or more other network nodes), and the UE may receive, configuration information. In some aspects, the UE may receive the configuration information via one or more of RRC signaling, one or more MAC control elements (CEs), and/or DCI, among other examples. In some aspects, the configuration information may include an indication of one or more configuration parameters (e.g., already known to the UE and/or previously indicated by the network node or other network device) for selection by the UE, and/or explicit configuration information for the UE to use to configure the UE, among other examples.

In some aspects, the configuration information may indicate that the UE is to identify, from multiple TRPs in communication with the UE, a first TRP to be associated with a CLI measurement, and to measure CLI using a receive beam associated with the first TRP. The receive beam associated with the first TRP may be, for example, the receive beam used for communications between the UE and the first TRP (e.g., previously configured via DCI). In some aspects, the configuration information may indicate that the UE is to identify, from multiple TRPs in communication with the UE, at least two TRPs to be associated with a CLI measurements, and to measure CLI for each of the at least two TRPs.

The UE may configure itself based at least in part on the configuration information. In some aspects, the UE may be configured to perform one or more operations described herein based at least in part on the configuration information.

As shown by reference number 710, in some aspects, the UE may receive a PDSCH communication from one of the TRPs or monitor for and/or receive a CORESET from one of the TRPs. The PDSCH reception and CORESET monitoring/reception may occur as part of regular communications from TRPs. While the information received by the UE via PDSCH and/or CORESET monitoring may not be relevant for measuring CLI, the spatial filter (e.g., receive beam) used by the UE to receive the PDSCH and/or monitor for the CORESET may be useful for measuring CLI, as described herein.

As shown by reference number 715, in some aspects, the UE may identify, from the multiple TRPs in communication with the UE, a TRP associated with a CLI measurement. For example, while the UE may have multiple TRPs to choose from (e.g., TRP A and TRP B), the UE may identify one of the TRPs for which the corresponding receive beam of the UE will be used to measure CLI during CLI measurement occasions.

In some aspects, when the UE is using a single DCI configuration (e.g., Mode 1) for communications with the multiple TRPs, the UE may identify the first TRP based at least in part on the first TRP being the source of the DCI for the single DCI configuration. For example, if TRP A was the TRP that provided the UE with DCI for multi-TRP communications, the receive beam associated with TRP A would be the receive beam used for CLI measurements.

In some aspects, configuration information, such as the configuration information received at 705, may indicate the first TRP. For example, configuration information may specifically identify TRP A as the first TRP to be used for CLI measurements. The TRP specified by the configuration information may be updated based on updated configuration information. Configuration information may be provided by the network node, one of the TRPs, or another network source.

In some aspects, the UE may be configured with a rule for determining a default TRP to identify as the first TRP. For example, the UE may be configured with a rule that specifies that the UE should use the receive beam associated with the TRP with the lowest TRP identifier among TRPs in communication with the UE.

In some aspects, the UE may identify, from the multiple TRPs in communication with the UE, at least two TRPs associated with CLI measurements. For example, the UE may identify some or all of the TRPs to be associated with CLI measurements. In some aspects, the UE may identify some or all of the TRPs in a manner similar to that for identifying a single TRP described herein, such as based on configuration information, a rule for determining TRPs, and/or the like. Methods of identifying which TRPs are identified and/or monitored, and how they are monitored, are described further herein.

As shown by reference number 720, the UE may measure CLI for each TRP identified by the UE. For example, in a situation where TRP A was identified, the UE may use the receive beam associated with TRP A for measuring CLI. As another example, where both TRP A and TRP B were identified, the UE may use the receive beams for both TRP A and TRP B to measure CLI.

In some aspects, the UE may, for multiple CLI measurement occasions, measure CLI for the TRP associated with a most recently monitored CORESET or a most recently received PDSCH communication. For example, the UE may be configured to measure CLI based on configuration information and/or a rule used to identify the TRP associated with the most recently monitored CORESET or the most recently received PDSCH communication. In this situation, the identified TRP to use for CLI measurement may change over time depending on which TRP was most recently used for PDSCH and/or CORESET communications.

In some aspects, the UE may alternate TRPs for which CLI is measured over CLI measurement occasions. For example, the UE may be configured to alternate TRPs based on configuration information and/or a rule specifying that the UE is to alternate TRPs over multiple CLI measurement occasions. In this situation, the UE may rotate between TRPs, ensuring each TRP is associated with a CLI measurement.

In some aspects, the UE may measure CLI for multiple identified TRPs at the same time using separate receive beams that each correspond to a most recently monitored CORESET or a most recently received PDSCH. For example, the UE may be configured to measure CLI based on configuration information and/or a rule used to identify the separate TRPs and/or receive beams associated with the most recently monitored CORESET or the most recently received PDSCH communication. For example, in a situation where SDM is configured for the multi-TRP communications, the UE may measure CLI RSSI and SRS RSSI over an entire bandwidth associated with the multiple identified TRPs. As another example, in a situation where FDM is configured for the multi-TRP communications, the UE may measure CLI RSSI in separate resource blocks in accordance with the resource blocks used by respective TRPs of the identified TRPs. In this situation, an SRS RSRP may be measured over an entire bandwidth of the identified TRPs, such that the UE measures an RSRP value for uplink SRS(s) transmitted by another UE or UEs over the entire bandwidth of the identified TRPs. In another example, in a situation where TDM is configured for the multi-TRP communications, the UE may measure CLI RSSI and SRS RSRP for different TRPs on different symbols of a same CLI measurement occasion. As described herein, when measuring CLI RSSI and/or SRS RSRP for one or more TRPs, the UE measures RSSI and/or SRSP RSRP using receive beams that correspond to respective TRPs which were identified for CLI measurement. The RSSI and/or SRS RSRP measured during the CLI measurement occasion(s) may provide an indication of the CLI experienced by the UE from other network devices during the CLI measurement occasion(s) and on the respective receive beams. For example, higher RSSI measurements and/or higher SRS RSRP measurements may indicate higher CLI. In some aspects, the CLI measurements may include RSSI measurements and/or SRS RSRP measurements.

Combinations of the foregoing methods may also be used to measure CLI in different configurations, enabling the UE to measure CLI in a variety of ways.

As shown by reference number 725, in some aspects, the UE may filter CLI results measured from a CLI measurement occasion. For example, in situations where the UE measures CLI for multiple TRPs, the UE may filter the results of measuring the CLI to obtain separate CLI measurement results for each TRP. In some aspects, because CLI measurements may have measurement times that differ from typical CLI measurements, the UE may adjust a Layer 3 filtering coefficient α of the results for a TRP to maintain the same filter time constant as if CLI were measured for a single TRP. For example, the coefficient α may be increased if the time interval between two adjacent CLI measurement occasions where CLI is measured for the same TRP increases, so that more weight is put on the CLI measured from the second of the two adjacent CLI measurement occasions.

As shown by reference number 730, the UE may transmit, and the network node and/or one or more of the TRPs may receive, one or more CLI reports based at least in part on measuring the CLI. In a situation where CLI is measured for one TRP, only one CLI report may be transmitted. In a situation where CLI is measured for multiple TRPs, the UE may transmit the CLI report in a variety of ways.

In some aspects, the UE may transmit a CLI report that corresponds to a strongest CLI measurement result associated with the TRPs. This enables the UE to report CLI for interference that may be most likely to interfere with the multi-TRP communications.

In some aspects, the UE may alternate transmitting CLI reports for different TRPs. This may enable the UE to provide each TRP with CLI information on a regular basis, regardless of results.

In some aspects, the UE may transmit a single CLI report that includes the separate CLI measurement results for some or all of the TRPs for which CLI was measured. This may enable the recipient to manage CLI across multiple TRPs with information included in a single CLI report.

In some aspects, event-based CLI reports may cause the UE to report CLI based on a certain condition being met. For example, the UE may be configured to transmit CLI reports only when an event-based CLI report has been triggered based on a CLI measurement. For example, a condition may be that the CLI measurement satisfies a CLI threshold.

In this way, the UE may determine which TRP(s) should be used for measuring CLI and, in some aspects, how to handle the results of measuring CLI for multiple TRPs. As a result, the UE may be more selective regarding which of multiple TRPs are chosen for measuring CLI, which may result in more relevant CLI measurements for the UE. More relevant CLI measurements are more likely to be useful in determining how the UE should avoid interference with another UE. The avoidance of interference may improve the quality of network communications and reduce network overhead that might otherwise be incurred correcting for interference.

As indicated above, FIG. 7 is provided as an example. Other examples may differ from what is described with respect to FIG. 7.

FIG. 8 is a diagram illustrating an example process 800 performed, for example, by a UE, in accordance with the present disclosure. Example process 800 is an example where the UE (e.g., UE 120) performs operations associated with spatial QCL for CLI for multiple TRPs.

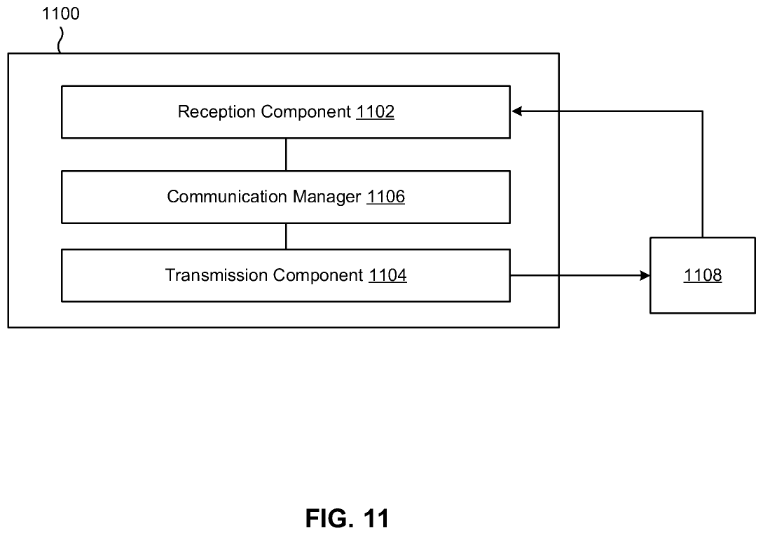

As shown in FIG. 8, in some aspects, process 800 may include identifying, from multiple TRPs in communication with the UE, a first TRP associated with a CLI measurement (block 810). For example, the UE (e.g., using communication manager 1106, depicted in FIG. 11) may identify, from multiple TRPs in communication with the UE, a first TRP associated with a CLI measurement, as described above.

As further shown in FIG. 8, in some aspects, process 800 may include measuring CLI using a receive beam associated with the first TRP (block 820). For example, the UE (e.g., using communication manager 1106, depicted in FIG. 11) may measure CLI using a receive beam associated with the first TRP, as described above.

Process 800 may include additional aspects, such as any single aspect or any combination of aspects described below and/or in connection with one or more other processes described elsewhere herein.

In a first aspect, the UE is in communication with the multiple TRPs with a single DCI configuration, and wherein identifying the first TRP comprises identifying the first TRP from the multiple TRPs based at least in part on the first TRP being a DCI source of the single DCI configuration.

In a second aspect, alone or in combination with the first aspect, process 800 includes receiving configuration information identifying the first TRP, and wherein identifying the first TRP comprises identifying the first TRP from the multiple TRPs based at least in part on the configuration information.

In a third aspect, alone or in combination with one or more of the first and second aspects, process 800 includes determining a default TRP for the CLI measurement, and wherein identifying the first TRP comprises identifying the first TRP from the multiple TRPs based at least in part on the first TRP being the default TRP.

In a fourth aspect, alone or in combination with one or more of the first through third aspects, determining the default TRP comprises determining the default TRP based at least in part on TRP identifiers of the multiple TRPs.

In a fifth aspect, alone or in combination with one or more of the first through fourth aspects, process 800 includes transmitting a CLI report based at least in part on measuring the CLI.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a network node, in accordance with the present disclosure. Example process 900 is an example where the network node (e.g., network node 110) performs operations associated with spatial QCL for CLI for multiple TRPs.

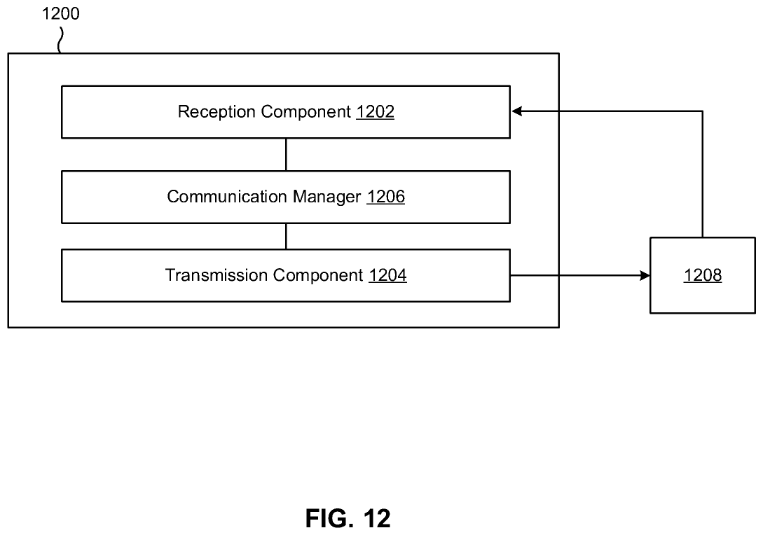

As shown in FIG. 9, in some aspects, process 900 may include transmitting, to a UE, configuration information, the configuration information indicating that the UE is to: identify, from multiple TRPs in communication with the UE, a first TRP associated with a CLI measurement; and measure CLI using a receive beam associated with the first TRP (block 910). For example, the network node (e.g., using transmission component 1204 and/or communication manager 1206, depicted in FIG. 12) may transmit, to a UE, configuration information, the configuration information indicating that the UE is to: identify, from multiple TRPs in communication with the UE, a first TRP associated with a CLI measurement; and measure CLI using a receive beam associated with the first TRP, as described above.

As further shown in FIG. 9, in some aspects, process 900 may include receiving a CLI report based at least in part on the configuration information (block 920). For example, the network node (e.g., using reception component 1202 and/or communication manager 1206, depicted in FIG. 12) may receive a CLI report based at least in part on the configuration information, as described above.

Process 900 may include additional aspects, such as any single aspect or any combination of aspects described below and/or in connection with one or more other processes described elsewhere herein.

In a first aspect, the UE is in communication with the multiple TRPs with a single DCI configuration, and wherein the configuration information indicates that the UE is to identify the first TRP from the multiple TRPs based at least in part on the first TRP being a DCI source of the single DCI configuration.

In a second aspect, alone or in combination with the first aspect, the configuration information identifies a specific TRP for CLI measurement, and wherein the configuration information indicates that the UE is to identify the first TRP from the multiple TRPs based at least in part on the configuration information identifying the specific TRP.

In a third aspect, alone or in combination with one or more of the first and second aspects, the configuration information indicates that the UE is to determine a default TRP for the CLI measurement, and wherein the first TRP is the default TRP.

In a fourth aspect, alone or in combination with one or more of the first through third aspects, the configuration information indicates that the UE is to determine the default TRP based at least in part on TRP identifiers of the multiple TRPs.

In a fifth aspect, alone or in combination with one or more of the first through fourth aspects, process 900 includes receiving a CLI report from the UE.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a UE, in accordance with the present disclosure. Example process 1000 is an example where the UE (e.g., UE 120) performs operations associated with spatial QCL for CLI for multiple TRPs.

As shown in FIG. 10, in some aspects, process 1000 may include identifying, from multiple TRPs in communication with the UE, at least two TRPs associated with CLI measurements (block 1010). For example, the UE (e.g., using communication manager 1106, depicted in FIG. 11) may identify, from multiple TRPs in communication with the UE, at least two TRPs associated with CLI measurements, as described above.

As further shown in FIG. 10, in some aspects, process 1000 may include measuring CLI for each of the at least two TRPs (block 1020). For example, the UE (e.g., using communication manager 1106, depicted in FIG. 11) may measure CLI for each of the at least two TRPs, as described above.

Process 1000 may include additional aspects, such as any single aspect or any combination of aspects described below and/or in connection with one or more other processes described elsewhere herein.

In a first aspect, measuring the CLI comprises for each of a plurality of CLI measurement occasions, measuring CLI for a TRP, of the at least two TRPs, associated with a most recently monitored control resource set or a most recently received physical downlink shared channel communication.

In a second aspect, alone or in combination with the first aspect, measuring the CLI comprises for a plurality of CLI measurement occasions, alternating TRPs for which CLI is measured.

In a third aspect, alone or in combination with one or more of the first and second aspects, measuring the CLI comprises for each of a plurality of CLI measurement occasions, measuring CLI for each of the at least two TRPs using receive beams that, for each of the at least two TRPs, correspond to a most recently monitored control resource set or a most recently received physical downlink shared channel communication.

In a fourth aspect, alone or in combination with one or more of the first through third aspects, the at least two TRPs are configured for spatial division multiplexing, and wherein measuring the CLI comprises measuring CLI RSSI and SRS RSRP over an entire bandwidth associated with the at least two TRPs.

In a fifth aspect, alone or in combination with one or more of the first through fourth aspects, the at least two TRPs are configured for frequency division multiplexing, and wherein measuring the CLI comprises measuring CLI RSSI in separate resource blocks in accordance with resource blocks used by respective TRPs of the at least two TRPs.

In a sixth aspect, alone or in combination with one or more of the first through fifth aspects, measuring the CLI further comprises measuring SRS RSRP over an entire bandwidth associated with the at least two TRPs.

In a seventh aspect, alone or in combination with one or more of the first through sixth aspects, the at least two TRPs are configured for time division multiplexing, and wherein measuring the CLI comprises measuring CLI RSSI and SRS RSRP for different TRPs of the at least two TRPs on different symbols of a same CLI measurement occasion of the plurality of CLI measurement occasions.

In an eighth aspect, alone or in combination with one or more of the first through seventh aspects, process 1000 includes filtering results of measuring the CLI to obtain separate CLI measurement results for each of the at least two TRPs.

In a ninth aspect, alone or in combination with one or more of the first through eighth aspects, process 1000 includes transmitting a CLI report based at least in part on a strongest CLI measurement result associated with the at least two TRPs.

In a tenth aspect, alone or in combination with one or more of the first through ninth aspects, process 1000 includes alternating CLI report transmissions for each of the at least two TRPs.

In an eleventh aspect, alone or in combination with one or more of the first through tenth aspects, process 1000 includes transmitting a CLI report that includes the separate CLI measurement results associated with each of the at least two TRPs.

In a twelfth aspect, alone or in combination with one or more of the first through eleventh aspects, process 1000 includes determining that an event-based CLI report has been triggered based on a single CLI measurement of the separate CLI measurements, and transmitting the event-based CLI report based at least in part on the determination.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication, in accordance with the present disclosure. The apparatus 1100 may be a UE, or a UE may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 140 described in connection with FIG. 1. As shown, the apparatus 1100 may communicate with another apparatus 1108, such as a UE or a network node (such as a CU, a DU, an RU, or a base station), using the reception component 1102 and the transmission component 1104.

In some aspects, the apparatus 1100 may be configured to perform one or more operations described herein in connection with FIGS. 6 and 7. Additionally, or alternatively, the apparatus 1100 may be configured to perform one or more processes described herein, such as process 800 of FIG. 8, process 1000 of FIG. 10, or a combination thereof. In some aspects, the apparatus 1100 and/or one or more components shown in FIG. 11 may include one or more components of the UE described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the UE described in connection with FIG. 2.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1108. In some aspects, the transmission component 1104 may include one or more antennas, a modem, a modulator, a transmit MIMO processor, a transmit processor, a controller/processor, a memory, or a combination thereof, of the UE described in connection with FIG. 2. In some aspects, the transmission component 1104 may be co-located with the reception component 1102 in a transceiver.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

The communication manager 1106 may identify, from multiple TRPs in communication with the UE, a first TRP associated with a CLI measurement. The communication manager 1106 may measure CLI using a receive beam associated with the first TRP.

The reception component 1102 may receive configuration information identifying the first TRP.

The communication manager 1106 may determine a default TRP for the CLI measurement.

The transmission component 1104 may transmit a CLI report based at least in part on measuring the CLI.

The communication manager 1106 may identify, from multiple TRPs in communication with the UE, at least two TRPs associated with CLI measurements. The communication manager 1106 may measure CLI for each of the at least two TRPs.

The communication manager 1106 may filter results of measuring the CLI to obtain separate CLI measurement results for each of the at least two TRPs.

The transmission component 1104 may transmit a CLI report based at least in part on a strongest CLI measurement result associated with the at least two TRPs.

The communication manager 1106 may alternate CLI report transmissions for each of the at least two TRPs.

The transmission component 1104 may transmit a CLI report that includes the separate CLI measurement results associated with each of the at least two TRPs.

The communication manager 1106 may determine that an event-based CLI report has been triggered based on a single CLI measurement of the separate CLI measurements.

The transmission component 1104 may transmit the event-based CLI report based at least in part on the determination.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication, in accordance with the present disclosure. The apparatus 1200 may be a network node, or a network node may include the apparatus 1200. In some aspects, the apparatus 1200 includes a reception component 1202, a transmission component 1204, and/or a communication manager 1206, which may be in communication with one another (for example, via one or more buses and/or one or more other components). In some aspects, the communication manager 1206 is the communication manager 150 described in connection with FIG. 1. As shown, the apparatus 1200 may communicate with another apparatus 1208, such as a UE or a network node (such as a CU, a DU, an RU, or a base station), using the reception component 1202 and the transmission component 1204.

In some aspects, the apparatus 1200 may be configured to perform one or more operations described herein in connection with FIGS. 6 and 7. Additionally, or alternatively, the apparatus 1200 may be configured to perform one or more processes described herein, such as process 900 of FIG. 9. In some aspects, the apparatus 1200 and/or one or more components shown in FIG. 12 may include one or more components of the network node described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the network node described in connection with FIG. 2. In some aspects, the reception component 1202 and/or the transmission component 1204 may include or may be included in a network interface. The network interface may be configured to obtain and/or output signals for the apparatus 1200 via one or more communications links, such as a backhaul link, a midhaul link, and/or a fronthaul link.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1208. In some aspects, the transmission component 1204 may include one or more antennas, a modem, a modulator, a transmit MIMO processor, a transmit processor, a controller/processor, a memory, or a combination thereof, of the network node described in connection with FIG. 2. In some aspects, the transmission component 1204 may be co-located with the reception component 1202 in a transceiver.

The communication manager 1206 may support operations of the reception component 1202 and/or the transmission component 1204. For example, the communication manager 1206 may receive information associated with configuring reception of communications by the reception component 1202 and/or transmission of communications by the transmission component 1204. Additionally, or alternatively, the communication manager 1206 may generate and/or provide control information to the reception component 1202 and/or the transmission component 1204 to control reception and/or transmission of communications.

The transmission component 1204 may transmit, to a UE, configuration information, the configuration information indicating that the UE is identify, from multiple TRPs in communication with the UE, a first TRP associated with a CLI measurement; and measure CLI using a receive beam associated with the first TRP. The reception component 1202 may receive a CLI report based at least in part on the configuration information.

The reception component 1202 may receive a CLI report from the UE.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:

Aspect 1: A method of wireless communication performed by a UE, comprising: identifying, from multiple TRPs in communication with the UE, a first TRP associated with a CLI measurement; and measuring CLI using a receive beam associated with the first TRP.

Aspect 2: The method of Aspect 1, wherein the UE is in communication with the multiple TRPs with a single DCI configuration; and wherein identifying the first TRP comprises: identifying the first TRP from the multiple TRPs based at least in part on the first TRP being a DCI source of the single DCI configuration.

Aspect 3: The method of any of Aspects 1-2, further comprising: receiving configuration information identifying the first TRP; and wherein identifying the first TRP comprises: identifying the first TRP from the multiple TRPs based at least in part on the configuration information, wherein identifying the first TRP comprises: identifying the first TRP from the multiple TRPs based at least in part on the configuration information.

Aspect 4: The method of any of Aspects 1-3, further comprising: determining a default TRP for the CLI measurement; and wherein identifying the first TRP comprises: identifying the first TRP from the multiple TRPs based at least in part on the first TRP being the default TRP, wherein identifying the first TRP comprises: identifying the first TRP from the multiple TRPs based at least in part on the first TRP being the default TRP.

Aspect 5: The method of Aspect 4, wherein determining the default TRP comprises: determining the default TRP based at least in part on TRP identifiers of the multiple TRPs.

Aspect 6: The method of any of Aspects 1-5, further comprising: transmitting a CLI report based at least in part on measuring the CLI.

Aspect 7: A method of wireless communication performed by a network node, comprising: transmitting, to a UE, configuration information, the configuration information indicating that the UE is to: identify, from multiple TRPs in communication with the UE, a first TRP associated with a CLI measurement; and measure CLI using a receive beam associated with the first TRP; and receiving a CLI report based at least in part on the configuration information.

Aspect 8: The method of Aspect 7, wherein the UE is in communication with the multiple TRPs with a single DCI configuration; and wherein the configuration information indicates that the UE is to identify the first TRP from the multiple TRPs based at least in part on the first TRP being a DCI source of the single DCI configuration.

Aspect 9: The method of any of Aspects 7-8, wherein the configuration information identifies a specific TRP for CLI measurement; and wherein the configuration information indicates that the UE is to identify the first TRP from the multiple TRPs based at least in part on the configuration information identifying the specific TRP.

Aspect 10: The method of any of Aspects 7-9, wherein the configuration information indicates that the UE is to determine a default TRP for the CLI measurement; and wherein the first TRP is the default TRP.

Aspect 11: The method of Aspect 10, wherein the configuration information indicates that the UE is to determine the default TRP based at least in part on TRP identifiers of the multiple TRPs.

Aspect 12: The method of any of Aspects 7-11, further comprising: receiving a CLI report from the UE.

Aspect 13: A method of wireless communication performed by a UE, comprising: identifying, from multiple TRPs in communication with the UE, at least two TRPs associated with CLI measurements; and measuring CLI for each of the at least two TRPs.

Aspect 14: The method of Aspect 13, wherein measuring the CLI comprises: for each of a plurality of CLI measurement occasions, measuring CLI for a TRP, of the at least two TRPs, associated with a most recently monitored control resource set or a most recently received physical downlink shared channel communication.

Aspect 15: The method of any of Aspects 13-14, wherein measuring the CLI comprises: for a plurality of CLI measurement occasions, alternating TRPs for which CLI is measured.

Aspect 16: The method of any of Aspects 13-15, wherein measuring the CLI comprises: for each of a plurality of CLI measurement occasions, measuring CLI for each of the at least two TRPs using receive beams that, for each of the at least two TRPs, correspond to a most recently monitored control resource set or a most recently received physical downlink shared channel communication.

Aspect 17: The method of Aspect 16, wherein the at least two TRPs are configured for spatial division multiplexing; and wherein measuring the CLI comprises: measuring CLI RSSI and SRS RSRP over an entire bandwidth associated with the at least two TRPs.

Aspect 18: The method of Aspect 16, wherein the at least two TRPs are configured for frequency division multiplexing; and wherein measuring the CLI comprises: measuring CLI RSSI in separate resource blocks in accordance with resource blocks used by respective TRPs of the at least two TRPs.

Aspect 19: The method of Aspect 18, wherein measuring the CLI further comprises: measuring SRS RSRP over an entire bandwidth associated with the at least two TRPs.

Aspect 20: The method of Aspect 16, wherein the at least two TRPs are configured for time division multiplexing; and wherein measuring the CLI comprises: measuring CLI RSSI and SRS RSRP for different TRPs of the at least two TRPs on different symbols of a same CLI measurement occasion of the plurality of CLI measurement occasions.

Aspect 21: The method of any of Aspects 13-20, further comprising: filtering results of measuring the CLI to obtain separate CLI measurement results for each of the at least two TRPs.

Aspect 22: The method of Aspect 21, further comprising: transmitting a CLI report based at least in part on a strongest CLI measurement result associated with the at least two TRPs.

Aspect 23: The method of Aspect 21, further comprising: alternating CLI report transmissions for each of the at least two TRPs.

Aspect 24: The method of Aspect 21, further comprising: transmitting a CLI report that includes the separate CLI measurement results associated with each of the at least two TRPs.

Aspect 25: The method of Aspect 21, further comprising: determining that an event-based CLI report has been triggered based on a single CLI measurement of the separate CLI measurements; and transmitting the event-based CLI report based at least in part on the determination.

Aspect 26: An apparatus for wireless communication at a device, comprising a processor; memory coupled with the processor; and instructions stored in the memory and executable by the processor to cause the apparatus to perform the method of one or more of Aspects 1-25.

Aspect 27: A device for wireless communication, comprising a memory and one or more processors coupled to the memory, the one or more processors configured to perform the method of one or more of Aspects 1-25.

Aspect 28: An apparatus for wireless communication, comprising at least one means for performing the method of one or more of Aspects 1-25.

Aspect 29: A non-transitory computer-readable medium storing code for wireless communication, the code comprising instructions executable by a processor to perform the method of one or more of Aspects 1-25.

Aspect 30: A non-transitory computer-readable medium storing a set of instructions for wireless communication, the set of instructions comprising one or more instructions that, when executed by one or more processors of a device, cause the device to perform the method of one or more of Aspects 1-25.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A user equipment (UE) for wireless communication, comprising:
a memory; and
one or more processors, coupled to the memory, configured to:
identify, from multiple transmission reception points (TRPs) in communication with the UE, a first TRP associated with a cross-link interference (CLI) measurement; and
measure CLI using a receive beam associated with the first TRP.

2. The UE of claim 1, wherein the UE is in communication with the multiple TRPs with a single DCI configuration; and
wherein the one or more processors, to identify the first TRP, are configured to:
identify the first TRP from the multiple TRPs based at least in part on the first TRP being a DCI source of the single DCI configuration.

3. The UE of claim 1, wherein the one or more processors are further configured to:
receive configuration information identifying the first TRP; and
wherein the one or more processors, to identify the first TRP, are configured to:
identify the first TRP from the multiple TRPs based at least in part on the configuration information.

4. The UE of claim 1, wherein the one or more processors are further configured to:
determine a default TRP for the CLI measurement; and
wherein the one or more processors, to identify the first TRP, are configured to:
identify the first TRP from the multiple TRPs based at least in part on the first TRP being the default TRP.

5. The UE of claim 4, wherein the one or more processors, to determine the default TRP, are configured to:
determine the default TRP based at least in part on TRP identifiers of the multiple TRPs.

6. The UE of claim 1, wherein the one or more processors are further configured to:
transmit a CLI report based at least in part on measuring the CLI.

7. A network node for wireless communication, comprising:
a memory; and
one or more processors, coupled to the memory, configured to:
transmit, to a user equipment (UE), configuration information, the configuration information indicating that the UE is to:
identify, from multiple transmission reception points (TRPs) in communication with the UE, a first TRP associated with a cross-link interference (CLI) measurement; and
measure CLI using a receive beam associated with the first TRP; and
receive a CLI report based at least in part on the configuration information.

8. The network node of claim 7, wherein the UE is in communication with the multiple TRPs with a single DCI configuration; and
wherein the configuration information indicates that the UE is to identify the first TRP from the multiple TRPs based at least in part on the first TRP being a DCI source of the single DCI configuration.

9. The network node of claim 7, wherein the configuration information identifies a specific TRP for CLI measurement; and
wherein the configuration information indicates that the UE is to identify the first TRP from the multiple TRPs based at least in part on the configuration information identifying the specific TRP.

10. The network node of claim 7, wherein the configuration information indicates that the UE is to determine a default TRP for the CLI measurement; and
wherein the first TRP is the default TRP.

11. The network node of claim 10, wherein the configuration information indicates that the UE is to determine the default TRP based at least in part on TRP identifiers of the multiple TRPs.

12. The network node of claim 7, wherein the one or more processors are further configured to:
receive a CLI report from the UE.

13. A UE for wireless communication, comprising:
a memory; and
one or more processors, coupled to the memory, configured to:
identify, from multiple transmission reception points (TRPs) in communication with the UE, at least two TRPs associated with cross-link interference (CLI) measurements; and
measure CLI for each of the at least two TRPs.

14. The UE of claim 13, wherein the one or more processors, to measure the CLI, are configured to:
for each of a plurality of CLI measurement occasions, measuring CLI for a TRP, of the at least two TRPs, associated with a most recently monitored control resource set or a most recently received physical downlink shared channel communication.

15. The UE of claim 13, wherein the one or more processors, to measure the CLI, are configured to:
for a plurality of CLI measurement occasions, alternating TRPs for which CLI is measured.

16. The UE of claim 13, wherein the one or more processors, to measure the CLI, are configured to:
for each of a plurality of CLI measurement occasions, measuring CLI for each of the at least two TRPs using receive beams that, for each of the at least two TRPs, correspond to a most recently monitored control resource set or a most recently received physical downlink shared channel communication.

17. The UE of claim 16, wherein the at least two TRPs are configured for spatial division multiplexing; and
wherein the one or more processors, to measure the CLI, are configured to:
measure CLI received signal strength indicator (RSSI) and sounding reference signal (SRS) reference signal received power (RSRP) over an entire bandwidth associated with the at least two TRPs.

18. The UE of claim 16, wherein the at least two TRPs are configured for frequency division multiplexing; and
wherein the one or more processors, to measure the CLI, are configured to:
measure CLI received signal strength indicator (RSSI) in separate resource blocks in accordance with resource blocks used by respective TRPs of the at least two TRPs.

19. The UE of claim 18, wherein the one or more processors, to measure the CLI, are configured to:
measure sounding reference signal (SRS) reference signal received power (RSRP) over an entire bandwidth associated with the at least two TRPs.

20. The UE of claim 16, wherein the at least two TRPs are configured for time division multiplexing; and
wherein the one or more processors, to measure the CLI, are configured to:
measure CLI received signal strength indicator (RSSI) and sounding reference signal (SRS) reference signal received power (RSRP) for different TRPs of the at least two TRPs on different symbols of a same CLI measurement occasion of the plurality of CLI measurement occasions.

21.-30. (canceled)
